(19) United States
(12) Patent Application Publication
(10) Pub. No.: US 2011/0175693 A1
(43) Pub. Date: Jul. 21, 2011

(54) Pickup Device Having Clamping and Magnetically Attractive Functions

(76) Inventor: Maan-Jyi Chang, We-Jih Hsiang (TW)

(21) Appl. No.: 12/689,514

(22) Filed: Jan. 19, 2010

(51) Int. Cl. H01F 7/02

(52) U.S. Cl. 335/285

(57) ABSTRACT

A pickup device includes a holding tube (21), a mounting sleeve (25) mounted on the holding tube, a magnetically attractive unit (27) mounted in the mounting sleeve, a clamping unit (26) mounted in the mounting sleeve and abutting the magnetically attractive unit, and a connecting rod (22) movably mounted in the holding tube and connected with the clamping unit to drive the clamping unit. Thus, the magnetically attractive unit is fully hidden in and will not protrude outwardly from the mounting sleeve at a normal state so that the magnetically attractive unit will not be attached to any metallic body and can reach the predetermined position or place easily and quickly to magnetically attract or clamp the desired parts or tools exactly and conveniently, thereby facilitating the operator picking up the desired parts or tools.

### BACKGROUND OF THE INVENTION

1. Field of the Invention

The present invention relates to a pickup device and, more particularly, to a pickup device that picks up tiny parts or smaller tools, such as screws, nuts, bolts, driver tips and the like.

2. Description of the Related Art

A conventional pickup device 1 in accordance with the prior art shown in FIGS. 5 and 6 comprises a holding tube 11, a magnetically attractive head 15 mounted on the lower end of the holding tube 11, a connecting rod 12 movably mounted in the holding tube 11 and having an upper end protruding outwardly from the upper end of the holding tube 11, a clamping unit 14 movably mounted in the holding tube 11 and connected with the lower end of the connecting rod 12 to move in concert with the connecting rod 12, and a press unit 13 mounted on the upper end of the connecting rod 12 to push the connecting rod 12 and the clamping unit 14 downward.

In operation, the pickup device 1 is extended into a larger object, such as a car, a working machine or an equipment to reach a predetermined position or place. At this time, the clamping unit 14 hidden in the holding tube 11. In such a manner, the magnetically attractive head 15 protrudes from the holding tube 11 and can be used to attract magnetic elements so as to pick up tiny parts or smaller tools, such as screws, nuts, bolts, driver tips and the like.

When the press unit 13 is pressed downward, the connecting rod 12 is moved to push the clamping unit 14 downward so that the clamping unit 14 protrudes outwardly from the lower end of the holding tube 11 as shown in FIG. 6. In such a manner, the clamping unit 14 protrudes outwardly from the holding tube 11 and can be used to clamp larger elements, such as wrenches, screwdrivers and the like.

However, the magnetically attractive head 15 constantly protrudes from the holding tube 11 as shown in FIG. 5 so that the magnetically attractive head 15 is easily attached to a metallic body magnetically and cannot reach the predetermined position or place easily and quickly, thereby greatly causing inconvenience to the operator when picking up the desired parts or tools.

### BRIEF SUMMARY OF THE INVENTION

In accordance with the present invention, there is provided a pickup device, comprising a holding tube, a mounting sleeve mounted on the holding tube, a magnetically attractive unit movably mounted in the mounting sleeve, a clamping unit movably mounted in the mounting sleeve and abutting the magnetically attractive unit to drive the magnetically attractive unit to move relative to the mounting sleeve, and a connecting rod movably mounted in the holding tube and connected with the clamping unit to drive the clamping unit to move relative to the mounting sleeve.

The primary objective of the present invention is to provide a pickup device having clamping and magnetically attractive functions.

According to the primary objective of the present invention, the magnetically attractive unit is fully hidden in and will not protrude outwardly from the mounting sleeve at a normal state so that the magnetically attractive unit will not be attached freely to any metallic body and can reach the predetermined position or place easily and quickly so as to magnetically attract or clamp the desired parts or tools exactly and conveniently, thereby facilitating the operator picking up the desired parts or tools.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a pickup device in accordance with the preferred embodiment of the present invention.

FIG. 2 is a front cross-sectional view of the pickup device as shown in

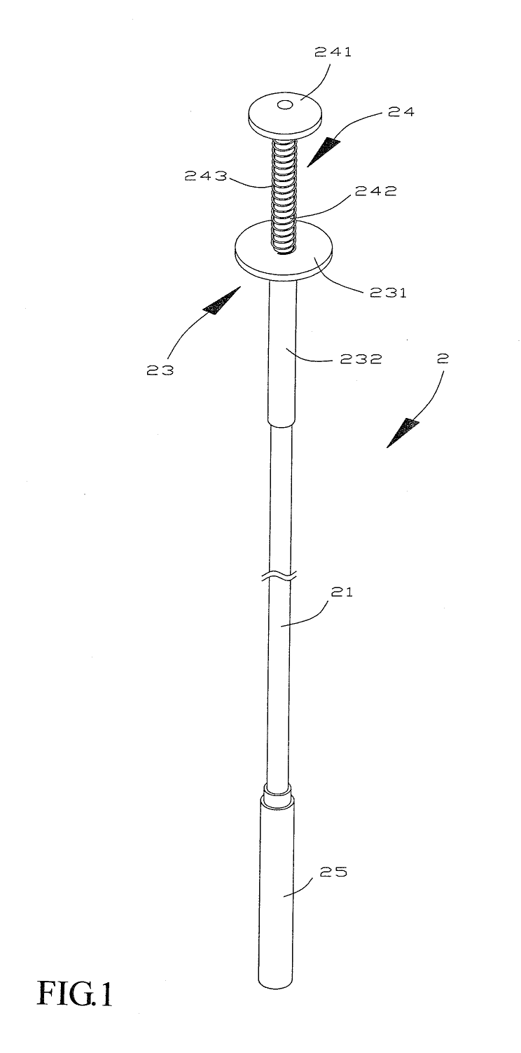

FIG. 1.

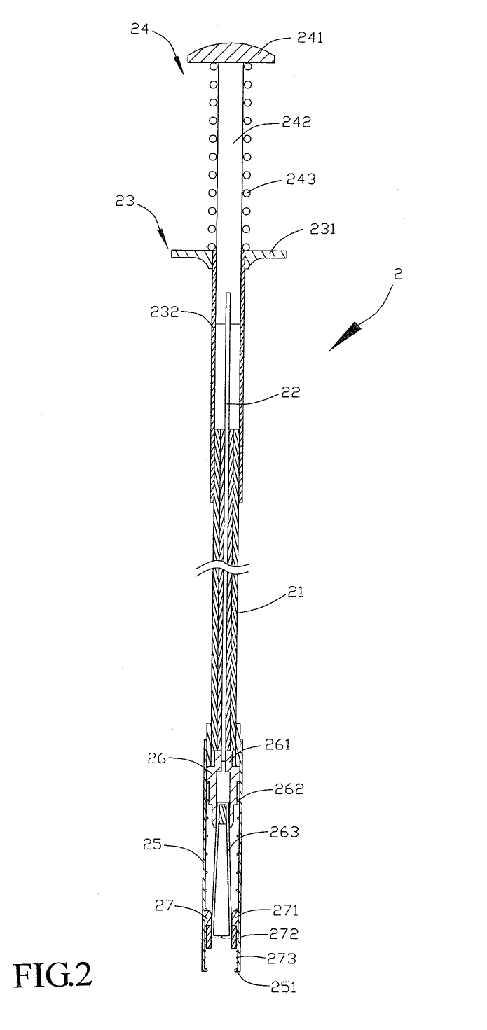

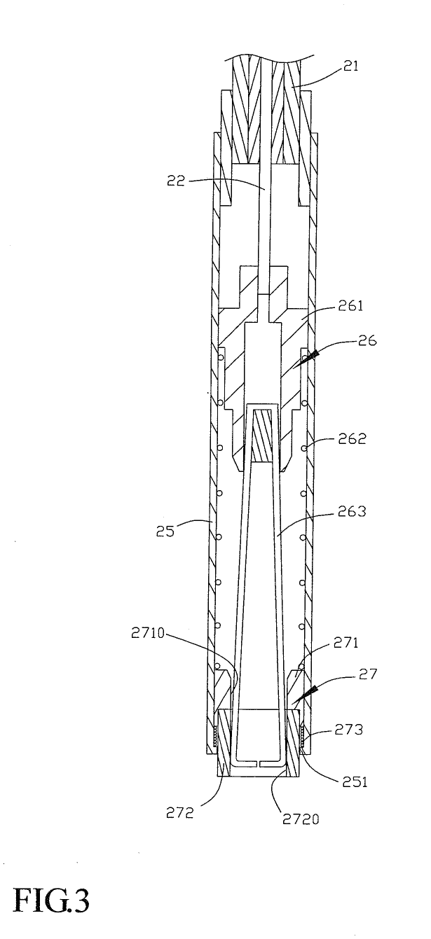

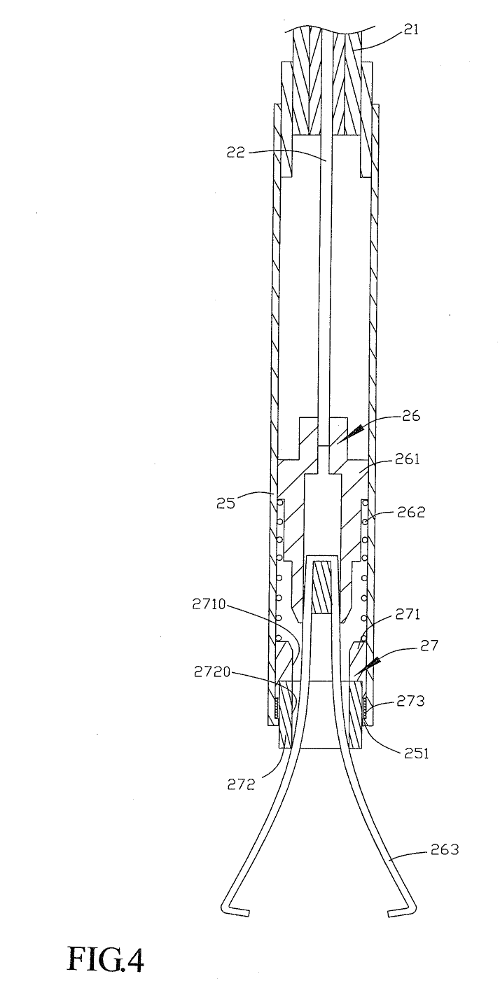

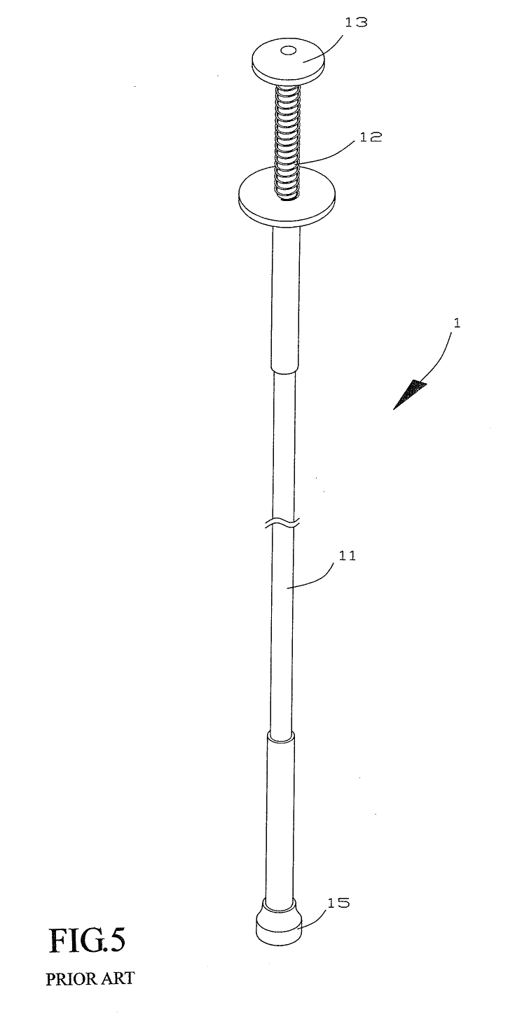

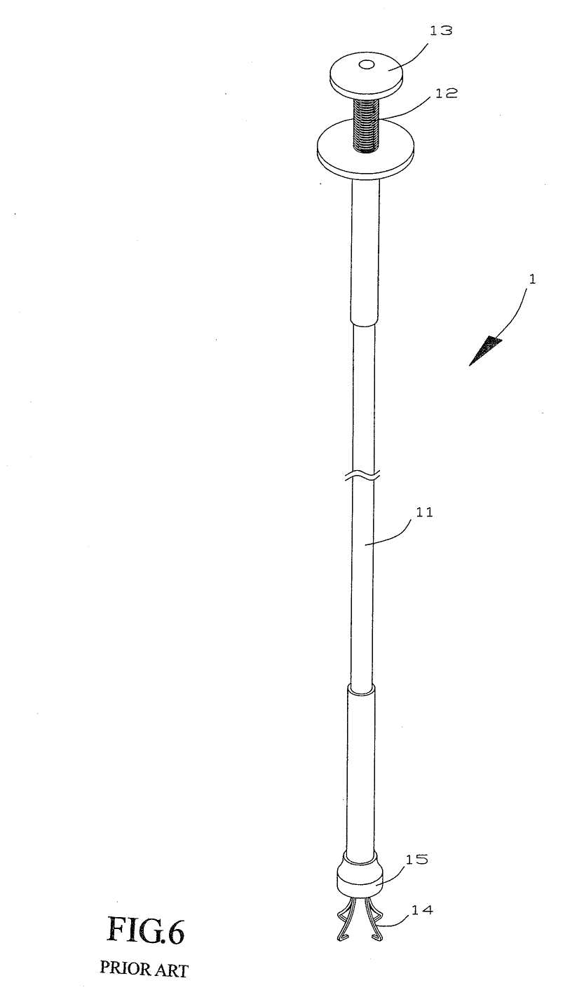

FIG. 3 is a locally enlarged operational view of the pickup device as shown in FIG. 2.

FIG. 4 is a schematic operational view of the pickup device as shown in FIG. 3.

FIG. 5 is a perspective view of a conventional pickup device in accordance with the prior art.

FIG. 6 is a schematic operational view of the conventional pickup device as shown in FIG. 5.

### DETAILED DESCRIPTION OF THE INVENTION

Referring to the drawings and initially to FIGS. 1-3, a pickup device 2 in accordance with the preferred embodiment of the present invention comprises a holding tube 21, a mounting sleeve 25 mounted on the holding tube 21, a magnetically attractive unit 27 movably mounted in the mounting sleeve 25, a clamping unit 26 movably mounted in the mounting sleeve 25 and abutting the magnetically attractive unit 27 to drive the magnetically attractive unit 27 to move relative to the mounting sleeve 25, a connecting rod 22 movably mounted in the holding tube 21 and connected with the clamping unit 26 to drive the clamping unit 26 to move relative to the mounting sleeve 25, a support unit 23 mounted on the holding tube 21, and a thrust unit 24 movably mounted on the support unit 23 and connected with the connecting rod 22 to drive the connecting rod 22 to move relative to the holding tube 21.

The holding tube 21 is made of flexible material and can be bent by a bending force. The mounting sleeve 25 is connected to the holding tube 21. The mounting sleeve 25 is made of iron and has an upper end mounted on a lower end of the holding tube 21 and a lower end provided with a limit flange 251 to limit the magnetically attractive unit 27. The limit flange 251 of the mounting sleeve 25 extends radially and inwardly from the lower end of the mounting sleeve 25.

The clamping unit 26 is fully hidden in the mounting sleeve 25 at a normal state. The clamping unit 26 includes a sliding seat 261 movably mounted in the mounting sleeve 25 and connected with the connecting rod 22 to move in concert with the connecting rod 22, an elastic member 262 biased between the sliding seat 261 and the magnetically attractive unit 27 to push the magnetically attractive unit 27 to protrude from the mounting sleeve 25 and to push the sliding seat 261 toward the connecting rod 22 and the holding tube 21, and a clamping claw 263 mounted on the sliding seat 261 to move in concert with the sliding seat 261 and extending through the magnetically attractive unit 27.

The sliding seat 261 of the clamping unit 26 has an upper end connected with a lower end of the connecting rod 22. The sliding seat 261 of the clamping unit 26 is movable to abut the lower end of the holding tube 21 at a normal state. The elastic member 262 of the clamping unit 26 is preferably a compression spring and is mounted on the sliding seat 261. The clamping claw 263 of the clamping unit 26 is elastic and has an upper end secured on a lower end of the sliding seat 261 and a lower end that extends through the magnetically attractive unit 27 and is movable to protrude outwardly from the mounting sleeve 25.

The magnetically attractive unit 27 is fully hidden in the mounting sleeve 25 at a normal state. The magnetically attractive unit 27 includes a slide 271 movably mounted in the mounting sleeve 25 and movable by the clamping unit 26, a magnetically attractive member 272 mounted on the slide 271 to move in concert with the slide 271 and movable to protrude outwardly from the mounting sleeve 25, and an elastic element 273 biased between the slide 271 and the limit flange 251 of the mounting sleeve 25 to push the slide 271 toward the clamping unit 26.

The elastic element 273 of the magnetically attractive unit 27 is preferably a compression spring which has an elastic force smaller than that of the elastic member 262 of the clamping unit 26. The elastic element 273 of the magnetically attractive unit 27 is mounted on the magnetically attractive member 272, and the elastic member 262 of the clamping unit 26 is biased between the sliding seat 261 and the slide 271 of the magnetically attractive unit 27. The slide 271 of the magnetically attractive unit 27 is located between the elastic member 262 of the clamping unit 26 and the elastic element 273 of the magnetically attractive unit 27. The slide 271 of the magnetically attractive unit 27 has an inner portion provided with a receiving chamber 2710 to allow passage of the clamping claw 263 of the clamping unit 26. The magnetically attractive member 272 of the magnetically attractive unit 27 has an inner portion provided with a receiving space 2720 to allow passage of the clamping claw 263 of the clamping unit 26.

The support unit 23 includes a support tube 232 having a lower end mounted on an upper end of the holding tube 21 and a limit plate 231 mounted on an upper end of the support tube 232. The support tube 232 of the support unit 23 is connected to the holding tube 21. The connecting rod 22 has an upper end extending into the support tube 232 of the support unit 23 and a lower end extending into the mounting sleeve 25.

The thrust unit 24 includes a push member 242 movably mounted on the support tube 232 of the support unit 23 and connected with the connecting rod 22 to move the connecting rod 22, a press head 241 mounted on the push member 242 to press the push member 242 toward the connecting rod 22, and a restoring member 243 mounted on the push member 242 and biased between the press head 241 and the limit plate 231 of the support unit 23. The push member 242 of the thrust unit 24 has a lower end movably mounted in the support tube 232 of the support unit 23 and connected with the upper end of the connecting rod 22, and the press head 241 of the thrust unit 24 is mounted on an upper end of the push member 242.

In operation, referring to FIGS. 2-4 with reference to FIG. 1, the pickup device 2 is extended into a larger object, such as a car, a working machine or an equipment to reach a predetermined position or place. At this time, the sliding seat 261 of the clamping unit 26 is pushed upward by the elastic member 262 of the clamping unit 26 to abut the lower end of the holding tube 21, so that the clamping claw 263 of the clamping unit 26 and the magnetically attractive member 272 of the magnetically attractive unit 27 are fully hidden in the mounting sleeve 25 at a normal state as shown in FIG. 2.

When the press head 241 of the thrust unit 24 is pressed toward the limit plate 231 of the support unit 23, the push member 242 of the thrust unit 24 is pushed to move the connecting rod 22 which moves the sliding seat 261 which compresses the elastic member 262 which moves the slide 271 which moves the magnetically attractive member 272 so that the magnetically attractive member 272 is moved to protrude outwardly from the mounting sleeve 25 as shown in FIG. 3. At this time, the clamping claw 263 of the clamping unit 26 is also moved by the sliding seat 261 of the clamping unit 26 and is still received in the magnetically attractive member 272 of the magnetically attractive unit 27. In such a manner, the magnetically attractive member 272 of the magnetically attractive unit 27 protrudes outwardly from the mounting sleeve 25 and can be used to attract magnetic elements so as to pick up tiny parts or smaller tools, such as screws, nuts, bolts, driver tips and the like.

When the press head 241 of the thrust unit 24 is further pressed toward the limit plate 231 of the support unit 23, the push member 242 of the thrust unit 24 is further pushed to move the connecting rod 22 which moves the sliding seat 261 which moves the clamping claw 263 so that the clamping claw 263 is moved to protrude outwardly from the mounting sleeve 25 as shown in FIG. 4. At this time, the magnetically attractive unit 27 is limited by the limit flange 251 of the mounting sleeve 25 so that the magnetically attractive unit 27 is not further moved downward. In such a manner, the clamping claw 263 of the clamping unit 26 protrudes outwardly from the mounting sleeve 25 and can be used to clamp larger elements, such as wrenches, screwdrivers and the like.

Accordingly, the magnetically attractive unit 27 is fully hidden in and will not protrude outwardly from the mounting sleeve 25 at a normal state so that the magnetically attractive unit 27 will not be attached freely to any metallic body and can reach the predetermined position or place easily and quickly so as to magnetically attract or clamp the desired parts or tools exactly and conveniently, thereby facilitating the operator picking up the desired parts or tools.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A pickup device, comprising:
a holding tube (21);
a mounting sleeve (25) mounted on the holding tube;
a magnetically attractive unit (27) movably mounted in the mounting sleeve;
a clamping unit (26) movably mounted in the mounting sleeve and abutting the magnetically attractive unit to drive the magnetically attractive unit to move relative to the mounting sleeve;
a connecting rod (22) movably mounted in the holding tube and connected with the clamping unit to drive the clamping unit to move relative to the mounting sleeve.

2. The pickup device of claim 1, wherein the clamping unit includes:
a sliding seat (261) movably mounted in the mounting sleeve and connected with the connecting rod to move in concert with the connecting rod;
an elastic member (262) biased between the sliding seat and the magnetically attractive unit to push the magnetically attractive unit to protrude from the mounting sleeve and to push the sliding seat toward the connecting rod and the holding tube;
a clamping claw (263) mounted on the sliding seat to move in concert with the sliding seat and extending through the magnetically attractive unit.

3. The pickup device of claim 2, wherein
the mounting sleeve has a lower end provided with a limit flange (251) to limit the magnetically attractive unit;
the magnetically attractive unit includes:
a slide (271) movably mounted in the mounting sleeve and movable by the clamping unit;
a magnetically attractive member (272) mounted on the slide to move in concert with the slide and movable to protrude outwardly from the mounting sleeve;
an elastic element (273) biased between the slide and the limit flange of the mounting sleeve to push the slide toward the clamping unit.

4. The pickup device of claim 3, wherein the elastic member of the clamping unit is biased between the sliding seat and the slide of the magnetically attractive unit.

5. The pickup device of claim 3, further comprising:
a support unit (23) mounted on the holding tube;
a thrust unit (24) movably mounted on the support unit and connected with the connecting rod to drive the connecting rod to move relative to the holding tube.

6. The pickup device of claim 5, wherein
the support unit includes:
a support tube (232) having a lower end mounted on an upper end of the holding tube;
a limit plate (231) mounted on an upper end of the support tube;
the thrust unit includes:
a push member (242) movably mounted on the support tube of the support unit and connected with the connecting rod to move the connecting rod;
a press head (241) mounted on the push member to press the push member toward the connecting rod;
a restoring member (243) mounted on the push member and biased between the press head and the limit plate of the support unit.

7. The pickup device of claim 1, wherein
the clamping unit is fully hidden in the mounting sleeve at a normal state;
the magnetically attractive unit is fully hidden in the mounting sleeve at a normal state.

8. The pickup device of claim 3, wherein the slide of the magnetically attractive unit has an inner portion provided with a receiving chamber to allow passage of the clamping claw of the clamping unit.

9. The pickup device of claim 3, wherein the magnetically attractive member of the magnetically attractive unit has an inner portion provided with a receiving space to allow passage of the clamping claw of the clamping unit.

10. The pickup device of claim 1, wherein the sliding seat of the clamping unit has an upper end connected with a lower end of the connecting rod.

11. The pickup device of claim 3, wherein
the mounting sleeve has an upper end mounted on a lower end of the holding tube;
the sliding seat of the clamping unit is movable to abut the lower end of the holding tube at a normal state.

12. The pickup device of claim 11, wherein the sliding seat of the clamping unit is pushed upward by the elastic member of the clamping unit to abut the lower end of the holding tube, so that the clamping claw of the clamping unit and the magnetically attractive member of the magnetically attractive unit are fully hidden in the mounting sleeve at a normal state.

13. The pickup device of claim 3, wherein the clamping claw of the clamping unit has an upper end secured on a lower end of the sliding seat and a lower end that extends through the magnetically attractive unit and is movable to protrude outwardly from the mounting sleeve.

14. The pickup device of claim 4, wherein the slide of the magnetically attractive unit is located between the elastic member of the clamping unit and the elastic element of the magnetically attractive unit.

15. The pickup device of claim 3, wherein the elastic element of the magnetically attractive unit is mounted on the magnetically attractive member.

16. The pickup device of claim 6, wherein the connecting rod has an upper end extending into the support tube of the support unit and a lower end extending into the mounting sleeve.

17. The pickup device of claim 16, wherein
the push member of the thrust unit has a lower end movably mounted in the support tube of the support unit and connected with the upper end of the connecting rod;
the press head of the thrust unit is mounted on an upper end of the push member.

18. The pickup device of claim 6, wherein
the mounting sleeve is connected to the holding tube;
the support tube of the support unit is connected to the holding tube.

19. The pickup device of claim 3, wherein
the elastic member of the clamping unit is a compression spring and is mounted on the sliding seat;
the elastic element of the magnetically attractive unit is a compression spring which has an elastic force smaller than that of the elastic member of the clamping unit.

20. The pickup device of claim 3, wherein the limit flange of the mounting sleeve extends radially and inwardly from the lower end of the mounting sleeve.
